(19) United States
(12) Patent Application Publication
(10) Pub. No.: US 2025/0319539 A1
(43) Pub. Date: Oct. 16, 2025

(54) ORBITAL WELDING HEAD

(71) Applicant: Illinois Tool Works Inc., Glenview, IL (US)

(72) Inventors: Marcel FOH, Markdorf (DE); Jürgen JÄCKLE, Bad Waldsee (DE); Oliver OESTRICH, Mühlhausen-Ehingen (DE)

(21) Appl. No.: 19/098,608

(22) Filed: Apr. 2, 2025

(30) Foreign Application Priority Data
Apr. 12, 2024 (DE) 10 2024 110 344.2

(51) Int. Cl. B23K 9/028; B23K 9/10; B23K 101/06

(52) U.S. Cl. CPC B23K 9/0286; B23K 9/10; B23K 2101/06

(57) ABSTRACT

Disclosed example orbital welding heads or an orbital welding apparatus for welding of tubes, wherein a light source is arranged in a welding chamber, being positioned diametrically opposed to the observation window. This arrangement of the light source of the observation window allows for a very reliable, precise alignment of end portions of tubes to be welded. According to a further aspect, a control device is provided for controlling the light source located in the welding chamber, so that different light signals can be emitted with the light source. According to a third aspect, the observation window is formed by a glass pane, wherein the glass pane has a darkening coating typical of welding glasses, wherein at least one front-facing section of the glass pane is exposed, which is configured so as to be not darkening or less darkening, thus allowing light to freely exit from this edge portion.

### RELATED APPLICATIONS

The present application claims the benefit of German (DE) Patent Application Serial No. 102024110344.2, filed Apr. 12, 2024. The entirety of German (DE) Patent Application Serial No. 102024110344.2 is expressly incorporated herein by reference.

### FIELD OF THE DISCLOSURE

The present disclosure relates to an orbital welding head having a light source in the welding chamber.

### BACKGROUND

DE 20 2014 100 284 U1 discloses an orbital welding apparatus having a light source in a welding chamber. A housing opening is formed on the housing of the welding chamber, which can be closed by a sliding cover having a transparent region. Alternatively, a hinged cap can also be used. Light-emitting diodes are provided as light sources, wherein two light-emitting diodes are arranged opposite one another in the welding chamber and adjacent to the opening.

U.S. Pat. No. 7,105,765 B2 discloses a further orbital welding apparatus that has a light source and a light sensor arranged diametrically opposed to the welding chamber, so that a connecting line between the light source and the light detector passes through the center of the tube ends to be welded. This allows for automatic monitoring of the positioning of the tube ends.

U.S. Pat. No. 5,837,966 A discloses an alignment module that can be mounted on an open orbital welding head. The alignment module comprises a light source and a light sensor arranged directly adjacent to one another. This allows for checking of the alignment of the tube ends to be welded. During operation of the orbital welding head, the alignment module is removed and the welding chamber is closed.

### SUMMARY

Orbital welding heads having a light source in the welding chamber are disclosed, substantially as illustrated by and described in connection with at least one of the figures, as set forth more completely in the claims.

### BRIEF SUMMARY OF THE DRAWINGS

This disclosure is explained below by way of example with reference to the drawings. The drawings show:

FIG. 1—an orbital welding head in a lateral view,

FIG. 2—the orbital welding head from FIG. 1 in a perspective view from an oblique top angle,

FIG. 3—a light source chamber of the orbital welding head according to FIG. 1 in a schematic cross-sectional view,

FIG. 4—a further embodiment of an orbital welding head, in which a front-facing edge portion of a glass pane forming an observation window is exposed, and

FIG. 5—the region of the orbital welding head with the glass pane exposed in the front-facing edge portion, in cross-section.

### DETAILED DESCRIPTION

The problem underlying the present disclosure is to create an orbital welding apparatus that can reliably and precisely check the alignment of the tube ends to be welded in a simple manner.

A further problem underlying the present disclosure is to create an orbital welding head that can improve the safety of operating an orbital welding apparatus in a simple manner.

According to a first aspect, the present disclosure relates to an orbital welding head for welding of tubes, comprising a housing having a first side wall with a first opening for inserting a first tube and a second side wall with a second opening for inserting a second tube, as well as a casing wall extending between the side walls and configured in a circumferential manner. The housing delimits an internal space that defines a welding chamber, wherein a light source is arranged in the welding chamber and an observation window is arranged in the casing wall.

This orbital welding head is characterized in that the light source in the welding chamber is arranged approximately diametrically opposed to the observation window.

Because the light source is arranged diametrically opposed to the observation window of the welding chamber, a gap between the tubes to be welded can be detected very precisely with the naked eye through the observation window. It can also be seen in which regions the gap is larger or smaller. If the tube ends of the two tubes to be welded are arranged exactly in abutment with one another, then no gap can be seen, and one cannot see the light source directly through the observation window. However, if a gap is formed, it creates a direct and free passage from the light source to the observation window, so that an observer looking through the observation window sees the light source directly through the gap. The observer can thus see the light intensity of the light source without any reduction.

The observation window can be a through-opening in the housing that is completely free, i.e., it is not covered by a glass pane or any other transparent body, but is merely formed by a hole in the housing. However, the observation window can also be covered by a temperature-stable glass pane which, similar to welding goggles, is provided with a UV-protective coating and is darkened so that there is no risk of eye injury for a user even during a regular welding process with an uncovered observation window. The glass pane can be provided with a darkening coating or can be made of a glass material that partially absorbs/reflects light.

The observation window can be a through-opening in the housing that can be closed by a flap for the welding operation, wherein the flap has a darkened glass pane that forms the observation window during the welding operation.

According to a second aspect of the present disclosure, an orbital welding head is provided for welding of tubes, comprising a housing having a first side wall with a first opening for inserting a first tube and a second side wall with a second opening for inserting a second tube, as well as a casing wall extending between the side walls and configured in a circumferential manner. The housing delimits an internal space that defines a welding chamber, wherein a light source is arranged in the welding chamber and an observation window is arranged in the housing. This orbital welding head is characterized in that a control device is provided for controlling the light source located in the welding chamber, so that different light signals can be emitted with the light source.

Thus, the light source located in the welding chamber can indicate different operating modes of the orbital welding apparatus to the user. The light from the light source either passes through the observation window or exits directly from the welding chamber when it is open. The observation window is formed by a free through-opening and/or a temperature-stable glass pane, which, similar to welding goggles, is darkened with a UV-protective coating, e.g., is designed with a coating for darkening, so that there is no risk of injury even during regular operation of the orbital welding apparatus.

With the light signals, a user of the orbital welding apparatus can be shown, for example, whether the welding chamber and/or the tubes are being purged with shielding gas or forming gas, whether the purging with forming gas is complete so that the welding process can start, whether the welding chamber should remain closed after the welding process in order to form a high-quality weld seam, or whether there are any defects in the orbital welding apparatus. In particular, the light signals can show the user whether they can perform manual work on the orbital welding apparatus, such as aligning the tube ends, or whether they should stay away from the welding chamber. This can be represented, for example, by different colors, in particular by the colors green or red.

There are two different modes when supplying forming gas. In one mode, permanent gas is supplied, and in the other mode, forming gas is only supplied during and, if necessary, shortly before the welding process.

The permanent gas is supplied at a small flow rate of e.g., 5 L/min, which can be increased to a stronger flow rate (e.g., 15-30 L/min) just before the actual welding process begins. As long as the permanent gas flows, it makes sense to indicate this by flashing.

In the second mode, the welding operation starts with a purging of forming gas (e.g., with a flow rate of 15-30 L/min) before the arc ignition occurs. It makes sense here to indicate both the purging with forming gas and the actual welding operation with corresponding light signals. The same or two different light signals can be used for the purging and the actual welding operation.

It can also be useful to display warnings for excessive deviations of a welding process control parameter (e.g., too high current deviation, insufficient forming gas flow, etc.). This can also be indicated on the power source, but it can be located far away (e.g., more than 5 m and up to 25 m) from the welding head.

A combination of both aspects of the present disclosure is particularly preferred, because in this case a single light source is used in order to align the tube ends and to inform the user of the orbital welding apparatus. Information is particularly needed during the pre- and post-processing of orbital welding, some of which is carried out manually.

The control device can be configured so as to output flashing light signals and/or light signals having different colors and/or brightness.

One or more additional observation panes can be arranged on one or both side walls, in particular adjacent to the light source. By providing these additional observation panes, light emitted from the light source can also penetrate outwardly substantially unhindered, even when the tube ends to be welded are already correctly positioned without gaps in the orbital welding head.

Instead of the additional observation panes, one or more optical fibers can be provided, which lead from the light source to the outside of the housing so that the light from the light source is transported outwards via the optical fibers. Because the optical fibers only conduct a small proportion of the light outwards from the welding chamber due to their small cross-section, no special protective measures are necessary on the optical fiber. With the optical fibers, the light from the light source, which is located within the welding chamber, can thus be transported unhindered outwards, where it can be perceived by the user of the orbital welding head at the exit or end of the optical fiber.

The light source is preferably separated from the rest of the welding chamber by a heat-resistant glass pane. This prevents damage to the light source during the welding process.

According to a third aspect of the present disclosure, an orbital welding head is provided for welding of tubes, comprising a housing having a first side wall with a first opening for inserting a first tube and a second side wall with a second opening for inserting a second tube, as well as a casing wall extending between the side walls and configured in a circumferential manner. The housing delimits an internal space that defines a welding chamber, wherein a light source is arranged in the welding chamber and a darkened observation pane is arranged in the housing. This orbital welding head is characterized in that the observation window is exposed at least in a front-facing edge portion so that light can exit at this front-facing edge portion.

Typically, the darkened pane is provided with a darkening coating. This coating is arranged either between adjacent glass panels in a laminated glass or on the surface facing outwards on the orbital welding head. Thus, the light can enter the glass pane unhindered up to the darkening coating and can exit at the front-facing edge portion.

Because a person cannot directly look at the arc through the front-facing edge portion, only indirect light from the arc can exit here, having been reflected or scattered at least once. In addition, the exit surface is very small, so there is no risk due to the arc produced during welding. On the other hand, when at least no welding operation is being carried out, the light from the light source can be easily detected from the outside, even if the housing is fully closed and the light primarily exits through the exposed front-facing edge portion.

During the welding operation, indirect light from the arc exits through the exposed front-facing edge portion of the glass pane. This exposed front-facing edge portion thus allows for observation of both the arc and the light source from the outside. Thus, light information from the interior of the welding chamber can be easily provided to the user while simultaneously allowing a direct view of the arc only through a darkened glass pane.

The light source can comprise one or more light-emitting diodes or one or more semiconductor lasers. In particular, the light source can comprise light-emitting diodes for emitting light of different colors, such that by adjusting different intensities of the light from the different light-emitting diodes, the color can be varied. The semiconductor laser(s) can be configured as wavelength-modulated lasers.

The control device of the orbital welding apparatus is preferably configured so as to switch off the light source during a welding operation. Because heat is generated during the welding operation, and, when the light source is switched on, heat is generated in the light source, turning on the light source simultaneously and performing the welding operation would provide twice the heat exposure to the light source. This can be avoided by turning off the light source when performing a welding operation, which significantly increases the life of the light source, in particular when the light source is a heat-sensitive light source, such as a light-emitting diode or a semiconductor laser.

A welding electrode is preferably provided in the welding chamber, which is movably arranged so that it can be moved around the tubes to be welded.

The housing of the orbital welding head is preferably divided into two housing parts, in particular along a plane that intersects the side walls approximately perpendicularly, and the housing parts are mounted pivotably in relation to one another about an axis of rotation and can be fixed to one another by means of a closure device.

A sensor can be provided on the housing in order to detect whether the housing is open or closed. Such a sensor can be, for example, a reed sensor. The sensor for detecting the open or closed position of the housing can be connected to the control device for controlling the light source, wherein the control device is then configured such that when the housing is open, the light source is reduced in its light output compared to the closed housing state.

Depending on this sensor, different light signals can be output when the position is open and closed.

It has been shown that the output of light signals in the open position of the orbital welding head is of particular importance. A user performing maintenance on the opened orbital welding head often pays all of his or her attention to the interior region of the welding chamber. If a light signal is then emitted from the light source arranged in the welding chamber, the user immediately perceives this and can react accordingly. For example, the power source can be located up to 25 m away and can be operated by a third person. A potential hazardous situation can be suddenly indicated to the user of the orbital welding head and is also impossible to overlook due to the light exiting the open orbital welding head.

The two parts of the housing each have an exchangeable clamping shell that can be adjusted to the shape of the tube to be welded. The clamping shells are ring-shaped and extend over a semi-circle. They can be inserted into the openings of the side walls, thus reducing the diameter of the openings.

The housing of the orbital welding head can be equipped with a shielding gas device for supplying shielding gas or forming gas into the welding chamber.

The light source can be designed so as to emit light with a light output of at least 750 mcd, in particular 900 mcd, in particular 1500 mcd, and most preferably at least 2000 mcd.

An orbital welding apparatus comprises an orbital welding head 1, a welding power source (not shown), and an elastic cable bundle or hose assembly 2 connecting the orbital welding head 1 to the welding power source.

The cable bundle 2 comprises one or more electrical cables for supplying the welding current and for exchanging data between the orbital welding head 1 and the welding power source. Furthermore, the cable bundle 2 contains at least one hose for supplying shielding gas in order to keep the oxygen concentration in the region of the weld point as low as possible. Suitable shielding gases include argon, helium, carbon dioxide, or nitrogen. A hose for supplying cooling water can also be provided.

The orbital welding head 1 comprises a first side wall 3 having a first opening 4 and a second side wall 5 having a second opening 6. The first side wall 3 and the second side wall 5 are arranged parallel to one another, and the two openings 4, 6 are each circular with approximately the same diameter and aligned concentrically to one another. A circumferential casing wall 7 is located between the first side wall 3 and the second side wall 5, such that the first side wall 3, the second side wall 5, and the casing wall 7 form a housing that delimits a welding chamber 8.

Through the first opening 4 and the second opening 6, an end portion of a first and a second tube (not shown) can be inserted into the welding chamber 8, respectively, such that the two end portions of the tubes are arranged so as to abut one another within the welding chamber 8.

In order to weld tubes of different diameters, clamping shells can be inserted into the first opening 4 and the second opening 6. These clamping shells each form a semi-circular ring portion in order to adapt the opening width of the first opening 4 and the second opening 6 to the diameter of the respective tubes. Such clamping shells or clamping pieces are known, per se (see e.g., DE 20 2014 100 284 U1).

A circumferential welding element (not shown) is located in the welding chamber 8 and can be moved at least once completely around the end portions of the tubes arranged in abutment with one another during the welding operation. The welding element is typically an electrical welding electrode.

The orbital welding head 1 comprises a handle 9, which is fixedly connected to the housing forming the welding chamber 8. This housing, which comprises the first side wall 3, the second side wall 5, and the casing wall 7 and thus delimits the welding chamber 8, is configured in two parts, wherein a separation plane 10 extends approximately perpendicular to the longitudinal extension of the handle 9. However, the separation plane 10 can also be configured in any inclined position for the longitudinal extension of the handle 9. The housing part 11 distanced from the handle 9 is pivotally connected to the housing part 13 connected to the handle 9 by means of a pivot joint 12. On the side diametrically opposed to the pivot joint 12, a tension hook 14 is provided, with which the two parts 11, 13 can be connected together and held together.

In the following, the housing part 11, which is connected to the housing part 13 attached to the handle 9 via the pivot joint 12, will be referred to as the pivotable housing part 11.

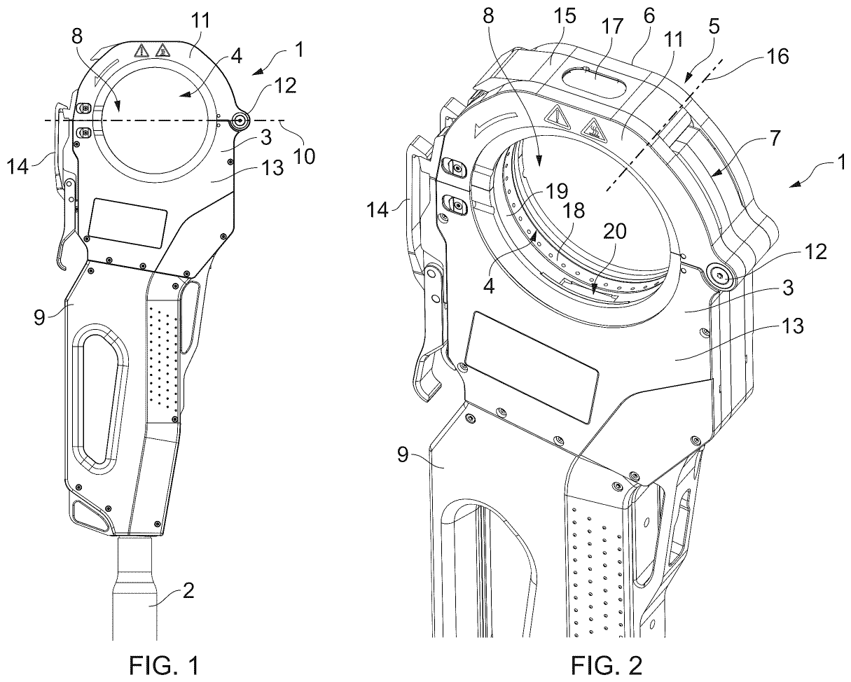

A hinged lid 15 is configured on the pivotable housing part 11 and can be opened about an axis of rotation 16. In the closed state of the hinged lid 15 (FIGS. 1 and 2), the hinged lid 15 closes a through-opening (not shown) in the casing wall 7.

Like most other components of the orbital welding head 1, the hinged lid 15 is made of metal, in particular aluminum, or a heat-resistant plastic, e.g., a PTFE or PEEK, and has an opening in the middle which is, for example, sealed with a temperature-stable glass pane 17. The glass pane 17 is, as is common in welding, formed as a darkened weld glass with UV protection. As a result, during the welding process, a user can look through the glass pane 17 at the arc in the welding chamber 8 without harming his or her eyes.

The casing wall 7 comprises a rotor 18 which delimits the welding chamber 8 inwardly and is configured with multiple circumferentially arranged nozzle openings for supplying the shielding gas. Adjacent to the rotor 18, there is a further ring portion 19 in which a light source 20 is arranged in the region diametrically opposed to the hinged lid 15 or the glass pane 17 arranged therein.

In the case of small welding heads, the rotor is often configured without nozzle openings.

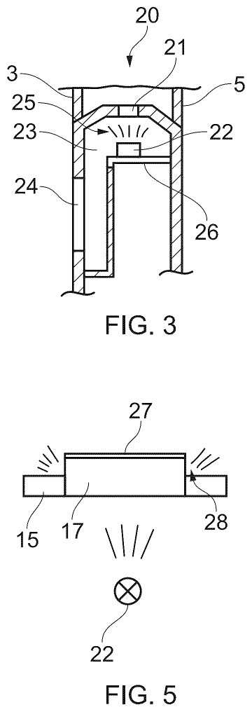

The light source 20 comprises a temperature-stable glass pane 21, wherein a light source element 22 is located behind the glass pane 21 from the perspective of the welding chamber 8 (FIG. 3). The light source element 22 preferably comprises multiple high-power light-emitting diodes and/or semiconductor lasers arranged with their radiation direction towards the glass pane 21. The light source element 22 is located in a light source chamber 23, which extends up to at least one of the two side walls 3, 5. A further glass pane is integrated into the side wall 3 and forms the observation window 24. The light source chamber 23 is preferably made of a reflective material in the regions adjacent to the glass pane 21, so that these regions form a reflector 25 that directs the light emitted by the light source element 22 that does not pass through the glass pane 21 towards the observation window 24, allowing it to exit from there.

The light source elements 22 are arranged on a printed circuit board 26. The region below the printed circuit board 26 (FIG. 3) is separated from the remaining light source chamber 23 and serves to accommodate electrical cables (not shown) or other components, such as heat dissipating sheets for dissipating the heat generated by the light source elements 22.

The observation window 24 and/or the glass panel 17 are provided with UV protection so that the UV light generated during the welding process is sufficiently inhibited when exiting the observation window 24.

The observation window 24 is preferably also provided with a darkening coating 27 in order to sufficiently retain the light generated during welding. Because this observation window 24 is arranged in the side wall 3, 5 such that it is not directly, rather only indirectly, irradiated with light from the arc, the observation window 24 can be less strongly darkened than the glass pane 17 of the hinged lid 15. Because the light source element 22 is located closer to the observation window 24 than the arc during operation of the orbital welding apparatus, the relative light intensity of the light from the light source element 22 is greater at the observation window 24 than at the glass pane 17 of the hinged lid 15. As a result, the light from the light source 20 can be seen much better through the observation window 24 than through the glass pane 17 of the hinged lid 15. Thus, it is possible, by means of a common light source 20, to align the tube end portions to one another (by detecting, when the hinged lid 15 is open, the gap between the tube end portions through the exposed observation window 24 due to the light source 22 arranged diametrically behind it and aligning the tube end portions accordingly) as well as to emit light signals, which are visible to the user at the observation window 24 and inform the user of certain states of the welding apparatus. These states can include certain operating states or hazardous conditions, which are explained in further detail below.

In the present exemplary embodiment, the light source 20 thus has two functions: first, the alignment of the end portions of the tubes, and second, informing the user about the operating states and/or hazardous conditions of the orbital welding apparatus.

In a simple embodiment, the light source 20 can only be used in order to align the end portions of the tubes. In such an embodiment, the observation window 24 can be omitted. Instead of the observation window 24, a digital display device can be provided on the handle 9 of the orbital welding head 1.

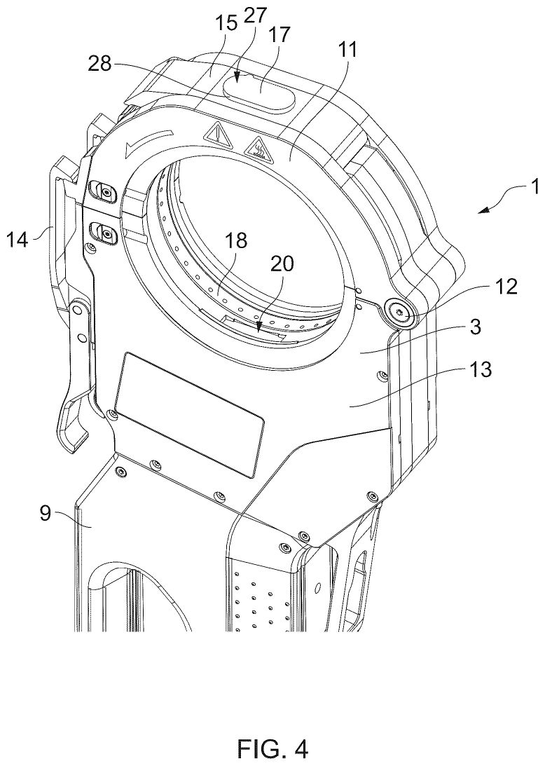

A further exemplary embodiment is explained below, in which a front-facing edge portion 28 of the glass pane 17 is exposed in the hinged lid 15 (FIGS. 4, 5). This further exemplary embodiment corresponds to the first exemplary embodiment explained above with reference to FIGS. 1 to 3. Unless stated otherwise below, it is consistent with the first exemplary embodiment.

In this second exemplary embodiment, the glass pane 17 protrudes slightly upward at the surface of the hinged lid 15 (FIGS. 4, 5). The glass pane 17 is provided with a darkening coating 27 on its surface facing away from the welding chamber 8 so that the light emitted by the light source element 22 can enter the glass pane 17. The darkening coating 27 prevents a significant portion of this light from exiting the surface of the glass pane 17 facing away from the welding chamber 8. However, diffuse light that is reflected or scattered in the welding chamber 8 and/or in the glass pane 17 reaches the circumferential edge portion 28 of the glass pane 17, which is not covered by a darkening coating 27, so that the light can freely exit at the edge portion 28 that protrudes from the upper surface of the hinged lid 15.

When no welding operation is being performed, a user of the orbital welding head 1 can easily detect the light signals emitted by the light source 20 into the welding chamber 8 through this exposed edge portion 28 of the glass pane 17, even when end portions of tubes are already in the welding chamber 8 and the housing is closed, so that the light from the light source 20 is diverted to the glass pane 17 around the end portions of the tubes to the glass pane 21 only via multiple reflections in the welding chamber 8.

On the surface of the glass pane 17 facing away from the welding chamber 8, these light signals are barely detectable due to the darkening coating 27.

In the exemplary embodiment shown in FIGS. 4 and 5, the glass pane 17 protrudes slightly from the surface of the hinged lid 15. Within the scope of the disclosure, it is also possible for the surface of the glass pane 17 to be aligned flush with the surface of the hinged lid 15, wherein only partial front-facing edge portions 28 of the glass pane 17 are exposed on the front side of the lid 15.

In the exemplary embodiment shown in FIGS. 4 and 5, the glass pane 17 is arranged in the lid 15 with edge portions 28 exposed on the front side. Within the scope of the disclosure, it is also possible to form the observation window 24 using a glass pane 17, for example in one of the two side walls 3, 5, wherein at least partial front-facing edge portions 28 of the glass pane 17 are exposed so as to enable substantially unimpeded light emission of the light signals from the light source 20. Even in such an embodiment, the exposed front-facing edge portions 28 are either not darkened or are less darkened than the surface of the respective glass pane 17 facing away from the housing.

Preferably, a sensor is integrated into the housing that can detect the closed position of the two housing parts 11, 13. The control device is configured so that, in the opened position, light signals of lower intensity are emitted from the light source 20 compared to the closed position.

The light signals can include flashing signals, color signals, and/or combined flashing and color signals. Signals in the color red are primarily used in order to indicate a hazardous or alarm state. Signals in the color green indicate a regular operating condition that does not mean a hazardous condition. With these signals, different states of the orbital welding apparatus, in particular the flooding of shielding gas, the application of a welding current, and certain calibration processes, can be indicated. After performing the welding operation, a corresponding light signal can indicate that the welding head 1 is still to be kept closed, so that the weld seam can cool gradually. Typical examples of conditions to be indicated by light signals are:
1. Permanent gas is active.
2. Warning after the welding process, in particular in case of too high a deviation during the welding process (e.g., too high current deviations).
3. Warnings at the power source to be acknowledged or checked.

### List of Reference Numerals

1 Orbital welding head
2 Cable bundle
3 First side wall
4 Opening
5 Side wall
6 Second opening
7 Casing wall
8 Welding chamber
9 Handle
10 Separation plane
11 Pivotable housing part
12 Pivot joint
13 Housing part
14 Tension hook
15 Hinged lid
16 Axis of rotation
17 Glass pane
18 Rotor
19 Ring portion
20 Light source
21 Glass pane
22 Light source element
23 Light source chamber
24 Observation window
25 Reflector
26 Printed circuit board
27 Darkening coating
28 Exposed edge portion

1. An orbital welding head for welding of tubes, comprising:
a housing comprising:
a first side wall having a first opening for inserting a first tube;
a second side wall having a second opening for inserting a second tube;
a casing wall that extends between the side walls and is circumferentially formed, wherein
the housing delimits an internal space that defines a welding chamber,
a light source is arranged in the welding chamber and an observation window is arranged in the casing wall, and
the light source is arranged in the welding chamber, being positioned approximately diametrically opposed to the observation window.

2. The orbital welding head according to claim 1, wherein a control device controls the light source located in the welding chamber, so that different light signals can be output with the light source.

3. The orbital welding head according to claim 2, wherein the control device is configured so as to output at least one of flashing light signals, light signals having different colors, or light signals having different brightness.

4. The orbital welding head according to claim 1, further comprising one or more optical fibers are arranged on one of the two side walls adjacent to the light source.

5. The orbital welding head according to claim 1, further comprising at least one observation pane is arranged on one of the two side walls adjacent to the light source.

6. The orbital welding head according to claim 1, wherein a darkened observation pane is arranged in the housing, and the darkened observation pane is exposed at least on a front-facing edge portion so that light can exit at the front-facing edge portion.

7. The orbital welding head according to claim 6, wherein the darkened observation pane has a darkening coating that is arranged either between adjacent glass panels in a laminated glass or on the surface of the glass pane facing outwards on the orbital welding head.

8. The orbital welding head according to claim 1, wherein the light source is separated from the rest of the welding chamber by a heat-resistant glass pane.

9. The orbital welding head according to claim 1, wherein the light source comprises one or more light-emitting diodes or one or more semiconductor lasers.

10. The orbital welding head according to claim 1, further comprising a welding electrode in the welding chamber, which is movably arranged so that the welding electrode can be moved around the tubes to be welded.

11. The orbital welding head according to claim 1, wherein the housing is divided into at least two parts along a plane that intersects the side walls approximately perpendicularly, and the parts are mounted pivotably in relation to one another about an axis of rotation and can be fixed to one another by means of a closure device.

12. The orbital welding head according to claim 11, wherein the at least two parts of the housing each have an exchangeable clamping shell that can be adjusted to the shape of the tube to be welded.

13. The orbital welding head according to claim 1, wherein the housing comprises a shielding gas device for supplying shielding gas into the welding chamber.

14. The orbital welding head according to claim 1, wherein the light source is designed so as to emit light with a light output of at least 750 mcd.

15. An orbital welding apparatus comprising a welding current source and an orbital welding head according to claim 1.
